(19) United States
(12) Patent Application Publication
(10) Pub. No.: US 2025/0183927 A1
(43) Pub. Date: Jun. 5, 2025

(54) ELECTRONIC DEVICE SUPPORTING ENDC-BASED EPA, AND OPERATING METHOD THEREOF

(71) Applicant: SAMSUNG ELECTRONICS CO., LTD., Suwon-si (KR)

(72) Inventors: Dongju LEE, Suwon-si (KR); Doil KANG, Suwon-si (KR); Minhong DO, Suwon-si (KR); Suho JIN, Suwon-si (KR); Eunsoo PARK, Suwon-si (KR)

(73) Assignee: SAMSUNG ELECTRONICS CO., LTD., Suwon-si (KR)

(21) Appl. No.: 19/045,275

(22) Filed: Feb. 4, 2025

Related U.S. Application Data
(63) Continuation of application No. PCT/KR2023/012524, filed on Aug. 24, 2023.

(30) Foreign Application Priority Data
Sep. 2, 2022 (KR) 10-2022-0111339
Oct. 13, 2022 (KR) 10-2022-0131662

(51) Int. Cl. H04B 1/04; H01Q 1/22; H01Q 3/26; H01Q 21/28

(52) U.S. Cl. CPC H04B 1/04; H01Q 3/26; H01Q 21/28; H01Q 1/2208; H04B 2001/0408

(57) ABSTRACT

An electronic device includes a radio-frequency integrated circuit (RFIC), a first switch configured to couple a transmitting end of the RFIC to at least one of a first path to a first antenna or a second path to a second antenna, a TRx module disposed between the first switch and the first antenna on the first path, the first antenna configured to transmit a first signal through first network communication, and disposed in a first part of the electronic device, a power amplifier (PA) module disposed between the first switch and the second antenna on the second path, the second antenna configured to transmit a second signal through second network communication, and disposed in a second part of the electronic device, and a second switch configured to couple at least one of the TRx module or the PA module to a feedback receiving end of the RFIC.

### CROSS-REFERENCE TO RELATED APPLICATIONS

This application is a continuation application of International Application No. PCT/KR2023/012524, filed on Aug. 24, 2023, which claims priority to Korean Patent Application No. 10-2022-0111339, filed on Sep. 2, 2022, and Korean Patent Application No. 10-2022-0131662, filed on Oct. 13, 2022, in the Korean Intellectual Property Office, the disclosures of which are incorporated by reference herein in their entireties.

### BACKGROUND

### 1. Field

The present disclosure relates to an electronic device supporting evolved universal terrestrial radio access network (E-UTRAN) new radio-dual connectivity (ENDC)-based equivalent phase antenna (EPA) and an operating method thereof.

### 2. Description of Related Art

A wireless cellular network, in accordance with a known telecommunication standard (e.g., a long-term evolution (LTE) specification, a new radio (NR) specification, a fifth generation (5G) specification), may experience difficulty in providing a communication service. In such a scenario, an evolved universal terrestrial radio access (E-UTRAN) NR dual connectivity (ENDC) scheme may be used, in which an existing commercialized E-UTRAN technology and a NR technology may be linked. That is, the ENDC scheme may provide a wireless communication service by simultaneously utilizing an LTE communication and a NR communication.

In addition to these advances, wireless devices and/or terminals (e.g., mobile phones, smartphones, user equipment (UE), tablet computers, laptop computers, or the like) may be deployed using new form factors. For example, products having rollable and/or foldable forms may be being released beyond typical bar forms that may have been previously used for wireless devices and/or terminals. However, in the case of a foldable terminal, various issues may occur due to a change in appearance and/or configuration of the foldable terminal according to a use environment.

### SUMMARY

According to an aspect of the disclosure, an electronic device includes a radio-frequency integrated circuit (RFIC), a first switch configured to couple a transmitting end of the RFIC to at least one of a first path to a first antenna or a second path to a second antenna, a TRx module disposed between the first switch and the first antenna on the first path, the first antenna configured to transmit a first signal output from the TRx module through first network communication, and disposed in a first part of the electronic device, a power amplifier (PA) module disposed between the first switch and the second antenna on the second path, the second antenna configured to transmit a second signal output from the PA module through second network communication, and disposed in a second part of the electronic device, and a second switch configured to couple at least one of the TRx module or the PA module with a feedback receiving end of the RFIC, wherein, in a folded state of the electronic device in which the first part and the second part are folded relative to each other, the first antenna and the second antenna are disposed in close proximity to each other, and a phase is matched between the first signal and the second signal based on a feedback signal transmitted from at least one of the TRx module or the PA module to the feedback receiving end of the RFIC through the second switch.

According to an aspect of the present disclosure, an operating method of an electronic device that is foldable includes: identifying whether the electronic device is in a folded state in which a first part of the electronic device and a second part of the electronic device are folded relative; based on identifying that the electronic device is in the folded state, controlling a first switch such that a transmitting end of an radio-frequency integrated circuit (RFIC) is coupled to a first path to a first antenna and a second path to a second antenna; matching a phase between a first signal output from a TRx module and a second signal output from a power amplifier (PA) module, based on a feedback signal transmitted, through a second switch, from at least one of the TRx module on the first path or the PA module on the second path to a feedback receiving end of the RFIC, wherein the TRx module is disposed between the first switch (820, 900) and the first antenna on the first path, and the PA module is disposed between the first switch and the second antenna on the second path, wherein, in the folded state of the electronic device, the first antenna and the second antenna are disposed in close proximity to each other, wherein the first antenna is configured to transmit the first signal through a first network communication, and wherein the second antenna is configured to transmit the second signal through a second network communication.

Additional aspects may be set forth in part in the description which follows and, in part, may be apparent from the description, and/or may be learned by practice of the presented embodiments.

### BRIEF DESCRIPTION OF DRAWINGS

The above and other aspects, features, and advantages of certain embodiments of the present disclosure may be more apparent from the following description taken in conjunction with the accompanying drawings, in which:

FIG. 1 is a block diagram of an electronic device in a network environment, according to an embodiment;

FIG. 2 is a diagram illustrating an operation of a folding axis of an electronic device, according to an embodiment;

FIG. 3 is a diagram illustrating a fully unfolded state, a folding state, and a fully folded state of an electronic device, according to an embodiment;

FIG. 4 is a diagram illustrating an out-folding scheme of an electronic device, according to an embodiment;

FIGS. 5, 6, and 7 are diagrams illustrating an antenna structure disposed within an electronic device, according to an embodiment;

FIG. 8 is a diagram illustrating a communication operation of an electronic device, according to an embodiment;

FIG. 9 is a diagram illustrating a switch, according to an embodiment;

FIG. 10 is a diagram describing an operating method of an electronic device, according to an embodiment;

FIGS. 11, 12, 13, and 14 are diagrams illustrating an operation of matching a phase between a first signal and a second signal, according to an embodiment;

FIGS. 15, 16, and 17 are diagrams illustrating an operation of matching a phase between a first signal and a second signal, according to an embodiment; and

FIG. 18 is a diagram illustrating an operating method of an electronic device, according to an embodiment.

### DETAILED DESCRIPTION

The following description with reference to the accompanying drawings is provided to assist in a comprehensive understanding of embodiments of the present disclosure defined by the claims and their equivalents. Various specific details are included to assist in understanding, but these details are considered to be exemplary only. Therefore, those of ordinary skill in the art may recognize that various changes and modifications of the embodiments described herein may be made without departing from the scope and spirit of the disclosure. In addition, descriptions of well-known functions and structures are omitted for clarity and conciseness.

Reference throughout the present disclosure to “one embodiment,” “an embodiment,” “an example embodiment,” or similar language may indicate that a particular feature, structure, or characteristic described in connection with the indicated embodiment is included in at least one embodiment of the present solution. Thus, the phrases “in one embodiment”, “in an embodiment,” “in an example embodiment,” and similar language throughout this disclosure may, but do not necessarily, all refer to the same embodiment. The embodiments described herein are example embodiments, and thus, the disclosure is not limited thereto and may be realized in various other forms.

It is to be understood that the specific order or hierarchy of blocks in the processes/flowcharts disclosed are an illustration of exemplary approaches. Based upon design preferences, it is understood that the specific order or hierarchy of blocks in the processes/flowcharts may be rearranged. Further, some blocks may be combined or omitted. The accompanying claims present elements of the various blocks in a sample order, and are not meant to be limited to the specific order or hierarchy presented.

The embodiments herein may be described and illustrated in terms of blocks, as shown in the drawings, which carry out a described function or functions. These blocks, which may be referred to herein as units or modules or the like, or by names such as device, logic, circuit, controller, counter, comparator, generator, converter, or the like, may be physically implemented by analog and/or digital circuits including one or more of a logic gate, an integrated circuit, a microprocessor, a microcontroller, a memory circuit, a passive electronic component, an active electronic component, an optical component, and the like.

In the present disclosure, the articles “a” and “an” are intended to include one or more items, and may be used interchangeably with “one or more.” Where only one item is intended, the term “one” or similar language is used. For example, the term “a processor” may refer to either a single processor or multiple processors. When a processor is described as carrying out an operation and the processor is referred to perform an additional operation, the multiple operations may be executed by either a single processor or any one or a combination of multiple processors.

Hereinafter, various embodiments of the present disclosure are described with reference to the accompanying drawings.

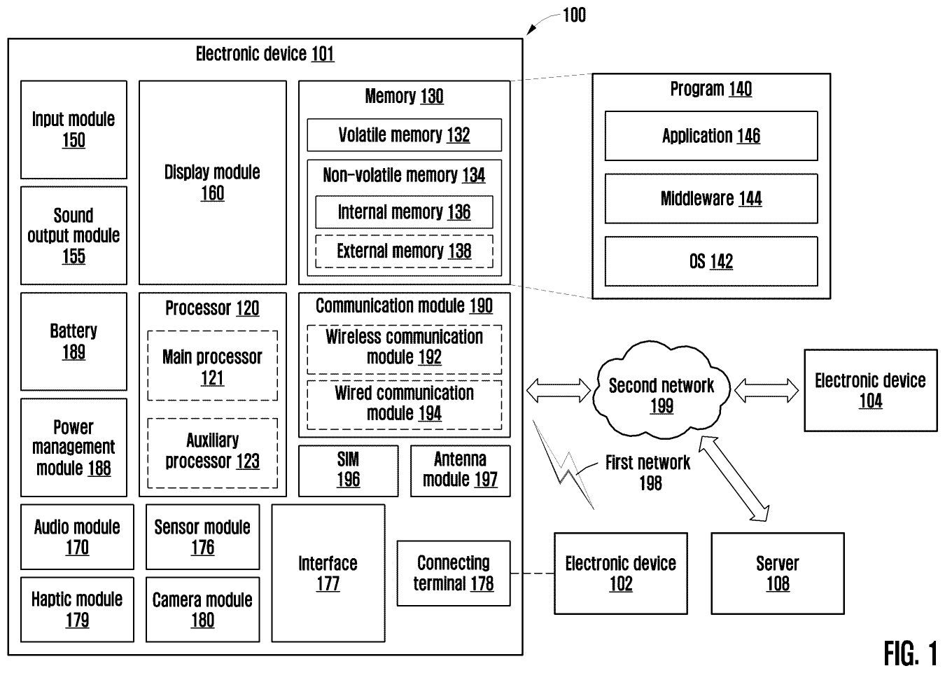

FIG. 1 is a block diagram illustrating an electronic device 101 in a network environment 100, according to embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, a memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one (e.g., the connecting terminal 178) of the above components may be omitted from the electronic device 101, or one or more other components may be added in the electronic device 101. In some embodiments, some of the components (e.g., the sensor module 176, the camera module 180, or the antenna module 197) may be integrated as a single component (e.g., the display module 160).

The processor 120 may execute, for example, software (e.g., a program 140) to control at least one other component (e.g., a hardware or software component) of the electronic device 101 connected to the processor 120, and may perform various data processing or computation. According to an embodiment, as at least a portion of data processing or computation, the processor 120 may store a command or data received from another component (e.g., the sensor module 176 or the communication module 190) in a volatile memory 132, process the command or the data stored in the volatile memory 132, and store resulting data in a non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that may be operable independently from, and/or in conjunction with, the main processor 121. For example, when the electronic device 101 includes the main processor 121 and the auxiliary processor 123, the auxiliary processor 123 may be adapted to consume less power than the main processor 121 and/or to be specific to a specified function. The auxiliary processor 123 may be implemented separately from the main processor 121 or as a part of the main processor 121.

The auxiliary processor 123 may control at least some of functions or states related to at least one (e.g., the display module 160, the sensor module 176, or the communication module 190) of the components of the electronic device 101, instead of the main processor 121 while the main processor 121 is in an inactive (e.g., sleep) state or along with the main processor 121 while the main processor 121 is in an active state (e.g., executing an application). According to an embodiment, the auxiliary processor 123 (e.g., an ISP or a CP) may be implemented as a portion of another component (e.g., the camera module 180 or the communication module 190) that may be functionally related to the auxiliary processor 123. According to an embodiment, the auxiliary processor 123 (e.g., an NPU) may include a hardware structure specified for artificial intelligence (AI) model processing. The AI model may be generated by machine learning. Such learning may be performed by, for example, the electronic device 101 in which artificial intelligence is performed, or performed via a separate server (e.g., the server 108). Learning algorithms may include, but may not be limited to, for example, supervised learning, unsupervised learning, semi-supervised learning, or reinforcement learning. The AI model may include a plurality of artificial neural network layers. An artificial neural network may include, for example, a deep neural network (DNN), a convolutional neural network (CNN), a recurrent neural network (RNN), a restricted Boltzmann machine (RBM), a deep belief network (DBN), and a bidirectional recurrent deep neural network (BRDNN), a deep Q-network, or a combination of two or more thereof, but the present disclosure is not limited thereto. The AI model may additionally or alternatively include a software structure other than the hardware structure.

The memory 130 may store various pieces of data used by at least one component (e.g., the processor 120 or the sensor module 176) of the electronic device 101. The various data may include, for example, software (e.g., the program 140) and input data and/or output data for a command related thereto. The memory 130 may include the volatile memory 132 or the non-volatile memory 134.

The program 140 may be stored as software in the memory 130, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output a sound signal to the outside of the electronic device 101. The sound output module 155 may include, for example, a speaker or a receiver. The speaker may be used for general purposes, such as, but not limited to, playing multimedia, playing recorded media, or the like. The receiver may be used to, but may not be limited to, receive an incoming call. According to an embodiment, the receiver may be implemented separately from the speaker or as a part of the speaker.

The display module 160 may visually provide information to the outside (e.g., a user) of the electronic device 101. The display module 160 may include, for example, a display, a hologram device, or a projector and control circuitry to control a corresponding one of the display, the hologram device, or the projector. According to an embodiment, the display module 160 may include a touch sensor adapted to sense a touch, or a pressure sensor adapted to measure an intensity of a force incurred by the touch.

The audio module 170 may convert a sound into an electric signal or vice versa. According to an embodiment, the audio module 170 may obtain the sound via the input module 150 or output the sound via the sound output module 155 or an external electronic device (e.g., an electronic device 102 such as a speaker or a headphone) directly or wirelessly connected to the electronic device 101.

The sensor module 176 may detect an operational state (e.g., power or temperature) of the electronic device 101 or an environmental state (e.g., a state of a user) external to the electronic device 101, and may generate an electric signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., by wire) or wirelessly. According to an embodiment, the interface 177 may include, for example, a high-definition multimedia interface (HDMI), a universal serial bus (USB) interface, a secure digital (SD) card interface, an audio interface, or the like.

The connecting terminal 178 may include a connector via which the electronic device 101 may be physically connected to an external electronic device (e.g., the electronic device 102). According to an embodiment, the connecting terminal 178 may include, for example, an HDMI connector, a USB connector, an SD card connector, an audio connector (e.g., a headphone connector), or the like.

The haptic module 179 may convert an electric signal into a mechanical stimulus (e.g., a vibration or a movement) or an electrical stimulus which may be recognized by a user via their tactile sensation and/or kinesthetic sensation. According to an embodiment, the haptic module 179 may include, for example, a motor, a piezoelectric element, or an electric stimulator.

The camera module 180 may capture a still image and/or moving images. According to an embodiment, the camera module 180 may include one or more lenses, image sensors, ISPs, or flashes.

The power management module 188 may manage power supplied to the electronic device 101. According to an embodiment, the power management module 188 may be implemented as, for example, at least a part of a power management integrated circuit (PMIC).

The battery 189 may supply power to at least one component of the electronic device 101. According to an embodiment, the battery 189 may include, for example, a primary cell which may not be rechargeable, a secondary cell which may be rechargeable, and/or a fuel cell.

The communication module 190 may support establishing a direct (e.g., wired) communication channel and/or a wireless communication channel between the electronic device 101 and the external electronic device (e.g., the electronic device 102, the electronic device 104, or the server 108) and performing communication via the established communication channel. The communication module 190 may include one or more communication processors that may be operable independently of the processor 120 (e.g., an AP) and that may support a direct (e.g., wired) communication and/or a wireless communication. According to an embodiment, the communication module 190 may include a wireless communication module 192 (e.g., a cellular communication module, a short-range wireless communication module, or a global navigation satellite system (GNSS) communication module) and/or a wired communication module 194 (e.g., a local region network (LAN) communication module, or a power line communication (PLC) module). A corresponding one of these communication modules may communicate with the external electronic device 104 via the first network 198 (e.g., a short-range communication network, such as, but not limited to, Bluetooth™, wireless-fidelity (Wi-Fi) direct, or infrared data association (IrDA)) and/or the second network 199 (e.g., a long-range communication network, such as a legacy cellular network, a 5G network, a next-generation communication network, the Internet, or a computer network (e.g., a LAN or a wide region network (WAN)). These various types of communication modules may be implemented as a single component (e.g., a single chip), or may be implemented as multi components (e.g., multiple chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The wireless communication module 192 may support a fifth generation (5G) network after a fourth generation (4G) network, and/or a next-generation communication technology (e.g., a new radio (NR) access technology). The NR access technology may support features and/or services that may include, but not be limited to, enhanced mobile broadband (eMBB), massive machine type communications (mMTC), or ultra-reliable and low-latency communications (URLLC). The wireless communication module 192 may support a high-frequency band (e.g., a mmWave band) to achieve a relatively high data transmission rate. The wireless communication module 192 may support various technologies for securing performance on a high-frequency band, such as, for example, beamforming, massive multiple-input and multiple-output (MIMO), full dimensional MIMO (FD-MIMO), an array antenna, analog beam-forming, and/or a large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 gigabits per second (Gbps) or more) for implementing eMBB, loss coverage (e.g., 164 dB or less) for implementing mMTC, or U-plane latency (e.g., 0.5 millisecond (ms) or less for each of downlink (DL) and uplink (UL), or a round trip of 1 ms or less) for implementing URLLC.

The antenna module 197 may transmit and/or receive a signal and/or power to and/or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in a communication network, such as the first network 198 or the second network 199, may be selected by, for example, the communication module 190 from the plurality of antennas. The signal and/or the power may be transmitted and/or received between the communication module 190 and the external electronic device via the at least one selected antenna. According to an embodiment, another component (e.g., a radio frequency integrated circuit (RFIC)) other than the radiating element may be additionally formed as a portion of the antenna module 197.

According to an embodiment, the antenna module 197 may form an mm Wave antenna module. According to an embodiment, the mmWave antenna module may include a PCB, an RFIC disposed on a first surface (e.g., a bottom surface) of the PCB or adjacent to the first surface and capable of supporting a designated a high-frequency band (e.g., the mm Wave band), and a plurality of antennas (e.g., array antennas) disposed on a second surface (e.g., a top or a side surface) of the PCB, or adjacent to the second surface and capable of transmitting and/or receiving signals in the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands and/or data may be transmitted and/or received between the electronic device 101 and the external electronic device 104 via the server 108 coupled with the second network 199. Each of the external electronic devices 102 or 104 may be and/or may include a device of the same type as or a different type from the electronic device 101. According to an embodiment, all or some of operations to be executed by the electronic device 101 may be executed at one or more external electronic devices (e.g., the external devices 102 and 104, and the server 108). For example, if the electronic device 101 needs to perform a function or a service automatically, or in response to a request from a user or another device, the electronic device 101, instead of, or in addition to, executing the function or the service, may request one or more external electronic devices to perform at least a portion of the function or the service. The one or more external electronic devices receiving the request may perform the at least part of the function or the service requested, or an additional function or an additional service related to the request, and may transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra-low-latency services using, e.g., distributed computing or MEC. In an embodiment, the external electronic device 104 may be and/or may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology, for example.

The electronic device, according to the embodiments disclosed herein, may be one of various types of electronic devices. The electronic device may include, for example, a portable communication device (e.g., a smartphone), a computer device, a portable multimedia device, a portable medical device, a camera, a wearable device, a home appliance device, or the like. According to an embodiment of the disclosure, the electronic device is not limited to those described above.

It should be appreciated that embodiments of the present disclosure and the terms used therein are not intended to limit the technological features set forth herein to particular embodiments and include various changes, equivalents, or replacements for a corresponding embodiment. In connection with the description of the drawings, like reference numerals may be used for similar or related components. It is to be understood that a singular form of a noun corresponding to an item may include one or more of the things, unless the relevant context clearly indicates otherwise. As used herein, “A or B,” “at least one of A and B,” “at least one of A or B,” “A, B or C,” “at least one of A, B and C,” and “at least one of A, B, or C,” may include any one of the items listed together in the corresponding one of the phrases, or all possible combinations thereof. Terms such as “1st,” and “2nd,” or “first” or “second” may simply be used to distinguish the component from other components in question, and do not limit the components in other aspects (e.g., importance or order). It is to be understood that if an element (e.g., a first element) is referred to, with or without the term “operatively” or “communicatively,” as “coupled with,” “coupled to,” “connected with,” or “connected to” another element (e.g., a second element), the element may be coupled with the other element directly (e.g., by wire), wirelessly, or via a third element.

As used in connection with embodiments of the disclosure, the term “module” may include a unit implemented in hardware, software, or firmware, and may interchangeably be used with other terms, for example, “logic”, “logic block”, “part”, or “circuitry”. A module may be a single integral component, or a minimum unit or part thereof, adapted to perform one or more functions. For example, according to an embodiment, the module may be implemented in a form of an application-specific integrated circuit (ASIC).

Embodiments as set forth herein may be implemented as software (e.g., the program 140) including one or more instructions that are stored in a storage medium (e.g., an internal memory 136 or an external memory 138) that is readable by a machine (e.g., the electronic device 101). For example, a processor (e.g., the processor 120) of the machine (e.g., the electronic device 101) may invoke at least one of the one or more instructions stored in the storage medium, and execute it. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method disclosed herein may be included and provided in a computer program product. The computer program product may be traded as a product between a seller and a buyer. The computer program product may be distributed in the form of a machine-readable storage medium (e.g., compact disc read-only memory (CD-ROM)), or be distributed (e.g., downloaded or uploaded) online via an application store (e.g., PlayStore™), or between two user devices (e.g., smartphones) directly. If distributed online, at least portion of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities, and some of the multiple entities may be separately disposed in different components. According to an embodiment, one or more of the above-described components may be omitted, or one or more other components may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to embodiments, operations performed by the module, the program, or another component may be carried out sequentially, in parallel, repeatedly, or heuristically, or one or more of the operations may be executed in a different order or omitted, or one or more other operations may be added.

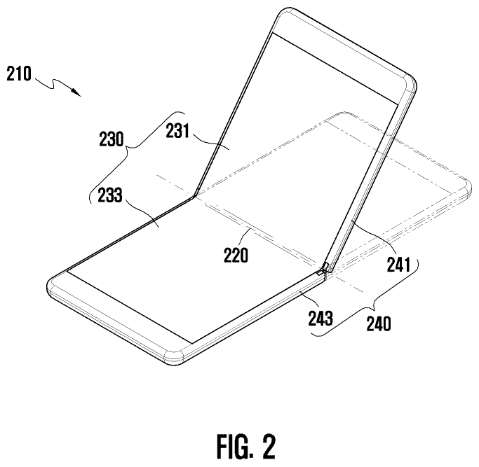

FIG. 2 is a diagram illustrating an operation of a folding axis of an electronic device, according to an embodiment.

Referring to FIG. 2, when an electronic device (e.g., the electronic device 101 of FIG. 1) includes a foldable display, a folding axis may be a horizontal direction.

When the folding axis is the horizontal direction, an electronic device 210 (e.g., the electronic device 101 of FIG. 1) may include a foldable display 230, a first housing 241, and a second housing 243. The foldable display 230 may be divided into a first area 231 and a second area 233 with respect to a folding axis 220 of a hinge. The first area 231 and the second area 233 of the foldable display 230 may have a rectangular shape with rounded corners, and may have a narrow bezel.

In the electronic device 210, according to an embodiment, the first area 231 and the second area 233 may be folded as the first housing 241 and the second housing 243 are folded.

The present disclosure is not limited to an embodiment of a case where the folding axis is a horizontal direction. For example, a multi-window may also be provided in the first area 231 and the second area 233 when the folding axis is a vertical direction.

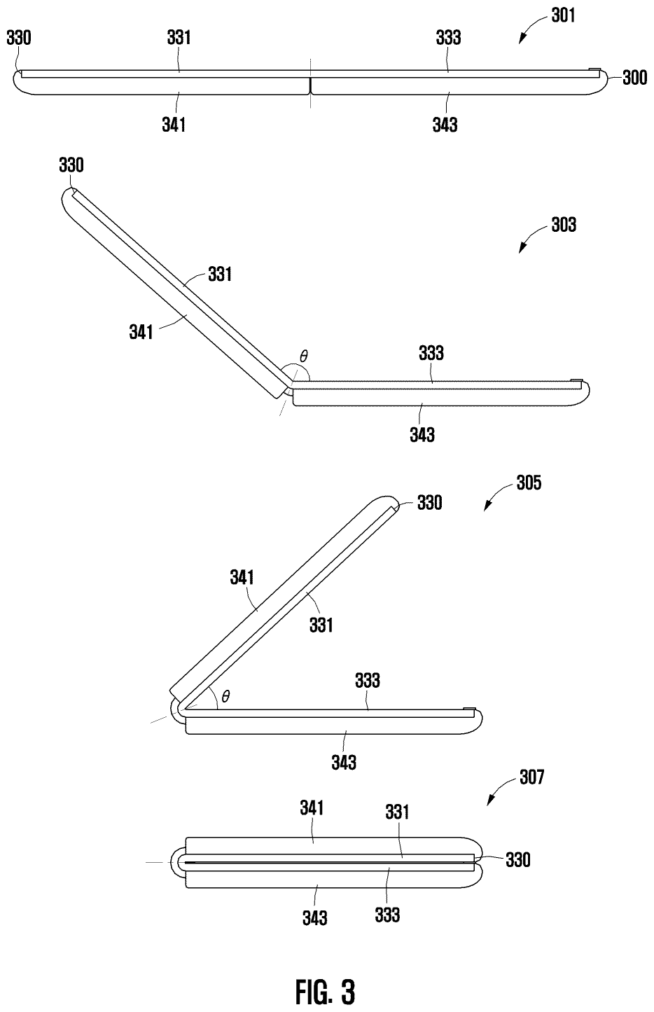

FIG. 3 is a diagram illustrating a fully unfolded state, a folding state, and a fully folded state of an electronic device, according to an embodiment.

Referring to FIG. 3, an electronic device 300 (e.g., the electronic device 101 of FIG. 1 or the electronic device 210 of FIG. 2) may include a foldable display 330 (e.g., the foldable display 230 of FIG. 2), a first housing 341, and a second housing 343.

A state 301 may represent a fully extended state or an unfolded state of the electronic device 300.

In the state 301, the electronic device 300 may be folded. For example, the electronic device 300 may be folded as the first housing 341 and/or the second housing 343 are folded.

According to an embodiment, as the electronic device 300 is folded, a first area 331 and a second area 333 of the foldable display 330 may form an angle θ with respect to a folding axis (e.g., the folding axis 220 of FIG. 2), such as a state 303 and a state 305. When the angle θ is within a predetermined range, the electronic device 300 may be referred to as being in a folding state, and the angle θ formed by the first area 331 and the second area 333 may be referred to as a folding angle.

According to an embodiment, the folding angle may be about 135 degrees (°) in the folding state 303, and the folding angle may be about 45° in the folding state 305. However, the present disclosure is not limited in this regard, and the folding angles corresponding to the folding states 303 and 305 may be different.

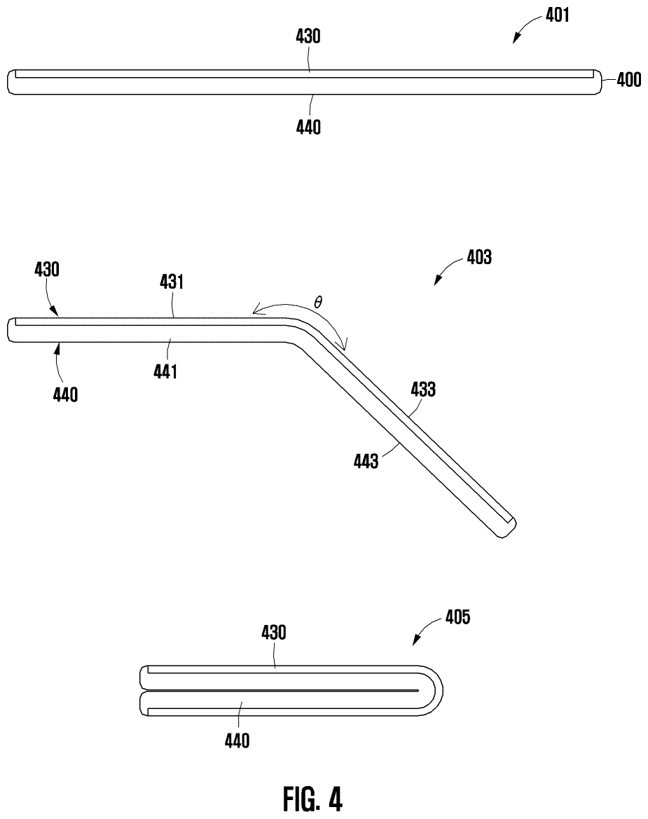

A state 307 may represent a fully folded state of the electronic device 300. At least a portion of the foldable display 330 may be substantially similar and/or the same in many respects as the display module 160 described with reference to FIG. 1. In an example shown in FIG. 3, the first area 331 and the second area 333 may be folded to face each other. That is, the screen may be folded inward. Such a folding scheme may be referred to as an in-folding scheme. Alternatively, the first area 331 and the second area 333 may be folded to face in opposite directions. That is, the screen may be implemented to be folded outwards. Such a folding scheme may be referred to as an out-folding scheme. An example in which the out-folding scheme is applied is described with reference to FIG. 4.

FIG. 4 is a diagram illustrating an out-folding scheme of an electronic device, according to an embodiment.

Referring to FIG. 4, an electronic device 400 (e.g., the electronic device 101 of FIG. 1, the electronic device 210 of FIG. 2, or the electronic device 300 of FIG. 3) may include an out-folding foldable display 430 (e.g., the foldable display 230 of FIG. 2). In the case of out-folding, only a folding direction is opposite to the case of in-folding described with reference to FIG. 3, so a repeated description related thereto may be omitted for the sake of brevity. A state 401 may represent a fully extended state or an unfolded state of the electronic device 400. In a state 403, the foldable display 430 may be out-folded, and the foldable display 430 may form a folding angle θ with a first area 431 (e.g., the first area 231 of FIG. 2) and a second area 433 (e.g., the second area 233 of FIG. 2). A state 405 may represent a fully folded state of the electronic device 400. At least a portion of the foldable display 430 may be substantially similar and/or the same in many respects as the display module 160 described with reference to FIG. 1. The present disclosure is not limited to an embodiment of a case where a folding axis is a horizontal direction and an in-folding scheme is used, and the electronic device may provide a multi-window in a first area and a second area divided based on a folding axis in the same manner when the folding axis is a vertical direction and an out-folding scheme is used, when the folding axis is a vertical direction and an in-folding scheme is used, and when the folding axis is a horizontal direction and an out-folding scheme is used.

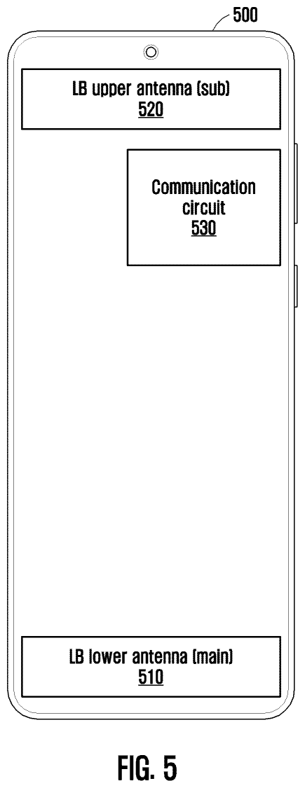

FIGS. 5 to 7 are diagrams illustrating an antenna structure disposed within an electronic device, according to an embodiment.

Referring to FIG. 5, an electronic device 500 (e.g., the electronic device 101 of FIG. 1, the electronic device 210 of FIG. 2, the electronic device 300 of FIG. 3, or the electronic device 400 of FIG. 4) may include a low band (LB) lower antenna 510, an LB upper antenna 520, and a communication circuit 530. For example, the LB lower antenna 510 may be and/or may include a main antenna for performing first network communication (e.g., long-term evolution (LTE) communication), and the LB upper antenna 520 may be and/or may include a sub-antenna for performing second network communication (e.g., 5G communication). However, the present disclosure is not limited to the above-described examples. In FIG. 5, for convenience of description, a description related to a path from the communication circuit 530 to the LB lower antenna 510 or the LB upper antenna 520 may be omitted.

The electronic device 500 may support an existing communication scheme, as well as, 5G communication. For example, the electronic device 500 may support existing communication schemes such as, but not limited to, LTE, third generation (3G), and/or second generation (2G) communication as well as a combination of carrier aggregation (CA) and evolved universal terrestrial radio access network (E-UTRAN) NR dual-connectivity (ENDC).

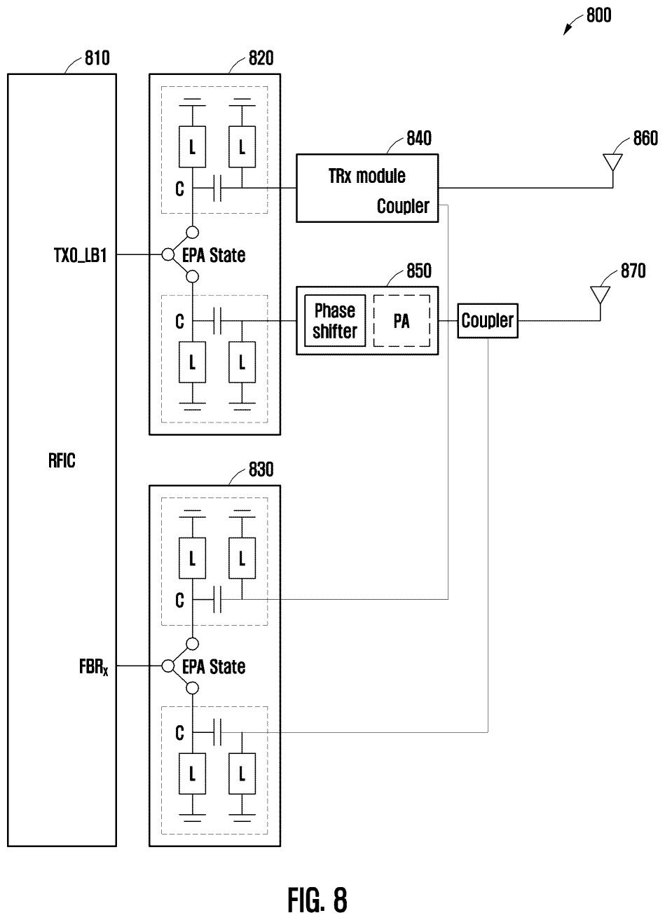

In order to support communications in various radio frequency (RF) bands in the electronic device 500, the LB lower antenna 510 and the LB upper antenna 520 may be disposed in a lower area and an upper area, respectively, in the electronic device 500, as shown in FIG. 5, and based on a hinge, which is a folding portion of a foldable display, an upper antenna area and a lower antenna area may be formed. In addition, to support LB-LB ENDC, the communication circuit 530 may be disposed between the LB lower antenna 510 and the LB upper antenna 520. The communication circuit 530 is described with reference to FIG. 8.

Due to the arrangement of the LB lower antenna 510 and the LB upper antenna 520, when the electronic device 500 is folded, the LB lower antenna 510 and the LB upper antenna 520 may come in contact with (or within a threshold proximity of) each other. A characteristic of the antenna may be determined by a metal length according to a wavelength of a frequency supported by the antenna. When the electronic device 500 is unfolded, the LB lower antenna 510 and the LB upper antenna 520 may not affect each other since the LB lower antenna 510 and the LB upper antenna 520 may not be in contact with each other, but when the electronic device 500 is folded, even if the LB lower antenna 510 and the LB upper antenna 520 are not in electrical contact with each other, the LB lower antenna 510 and the LB upper antenna 520 may affect each other, and characteristics of the antenna that may have been intended for the design of the antenna may change.

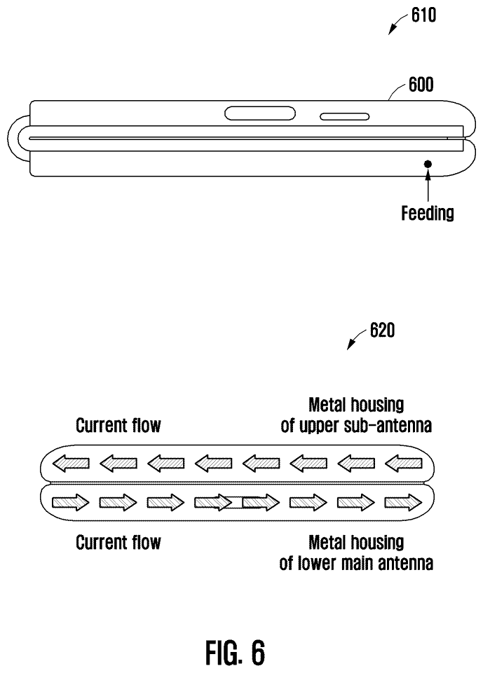

Referring to FIG. 6, a side surface 610 and a front surface 620 of an electronic device 600 (e.g., the electronic device 101 of FIG. 1, the electronic device 210 of FIG. 2, the electronic device 300 of FIG. 3, the electronic device 400 of FIG. 4, or the electronic device 500 of FIG. 5) when the electronic device 600 is folded is illustrated. Hereinafter, for convenience of description, the electronic device 600 being folded may also be expressed as the electronic device 600 being closed, and the electronic device 600 being unfolded may also be expressed as the electronic device 600 being opened.

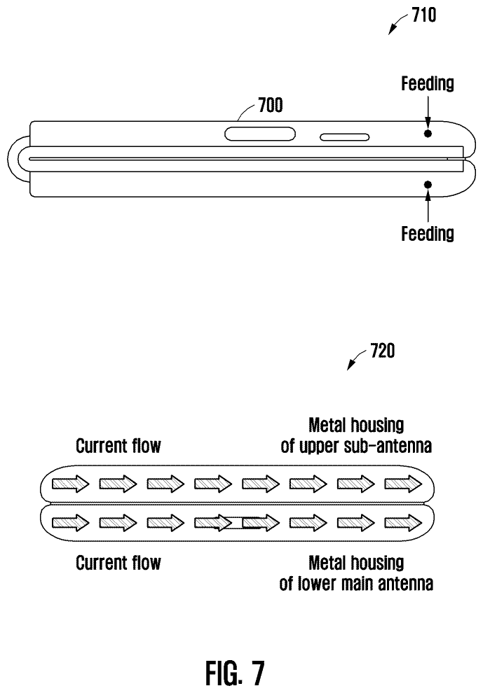

Arrows displayed on the front surface 620 may indicate a current flow by antennas (e.g., the LB lower antenna 510 or the LB upper antenna 520 of FIG. 5). As shown in the side surface 610, since feeding may be formed only at a lower end and the arrows displayed at an upper end and a lower end of the front surface 620 face different directions, the antennas may not normally transmit an RF signal. In order to prevent performance degradation of the antennas when the electronic device 600 is folded, an equivalent phase antenna (EPA) may be applied, and the current flow may be as shown in FIG. 7 when the EPA is applied.

Referring to FIG. 7, a side surface 710 and a front surface 720 of an electronic device 700 (e.g., the electronic device 101 of FIG. 1, the electronic device 210 of FIG. 2, the electronic device 300 of FIG. 3, the electronic device 400 of FIG. 4, the electronic device 500 of FIG. 5, or the electronic device 600 of FIG. 6) to which an EPA is applied and folded is illustrated.

A basic operation of the EPA may be performed such that a substantially similar and/or the same signal may be radiated from the antennas (e.g., the LB lower antenna 510 or the LB upper antenna 520 of FIG. 5). Due to the EPA, feeding may be formed at the same position at an upper end and a lower end, as shown in the side surface 710, such that a current flow by the antennas may be formed in the same direction as the arrows shown on the front surface 720. An RF signal may be radiated through the antennas when performance reduction due to current flow of the antennas is minimized.

FIG. 8 is a diagram illustrating a communication operation of an electronic device, according to an embodiment.

Referring to FIG. 8, an electronic device 800 (e.g., the electronic device 101 of FIG. 1, the electronic device 210 of FIG. 2, the electronic device 300 of FIG. 3, the electronic device 400 of FIG. 4, the electronic device 500 of FIG. 5, the electronic device 600 of FIG. 6, or the electronic device 700 of FIG. 7) may include an RFIC 810, a first switch 820, a second switch 830, a TRx module 840, a PA module 850, a first antenna 860 (e.g., the LB lower antenna 510 of FIG. 5), and a second antenna 870 (e.g., the LB upper antenna 520 of FIG. 5).

The electronic device 800 may efficiently support an EPA by improving transmission performance in an EPA state while also supporting ENDC, dividing a transmission path into an upper end and a lower end through the first switch 820 without dividing transmission and reception paths, blocking errors due to a phase difference of the transmission path, and compensating for the phase difference of the transmission path.

The RFIC 810 may mix a transmission signal into an RF signal and control an RF front end (RFFE). The RFFE may include RF elements such as, but not limited to, a duplexer, a diplexer, and/or a coupler for connecting the first antenna 860 and the second antenna 870. In FIG. 8, for convenience of description, at least one of the RFFE may be omitted.

The first switch 820 may connect a transmitting end (e.g., TX0_LB1) of the RFIC 810 to a first path to the first antenna 860 and/or to a second path to the second antenna 870. For example, the first switch 820 may be a single pole four throw (SP4T) switch configured to switch one input to four (4) paths, respectively, or switch two (2) or three (3) paths simultaneously.

The TRx module 840 may be disposed between the first switch 820 and the first antenna 860 on the first path. The TRx module 840 may amplify a transmission signal, or process a reception signal received from the first antenna 860.

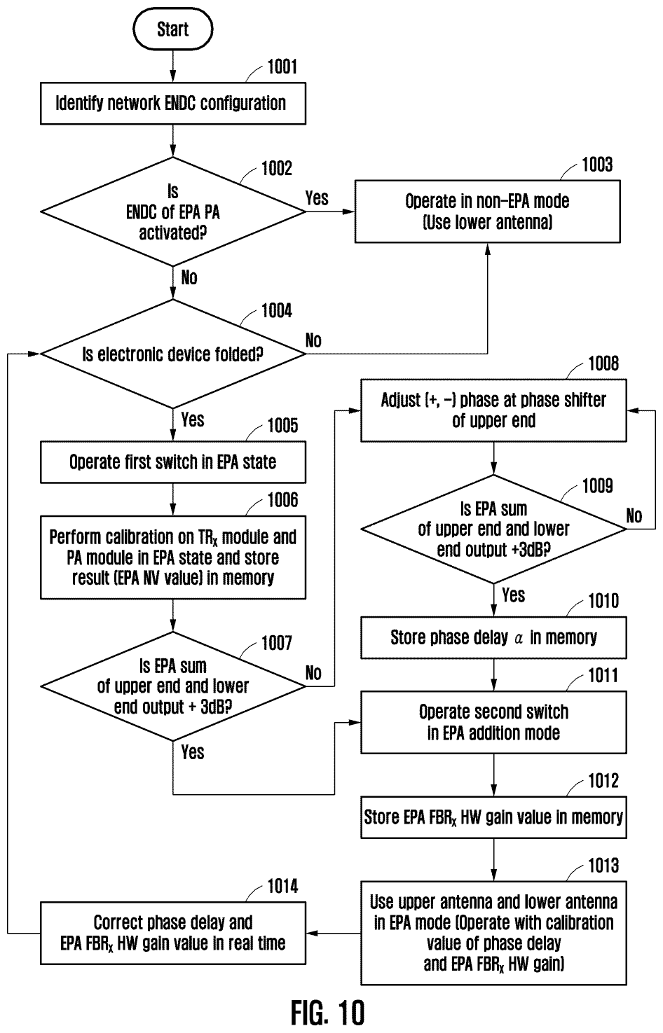

The PA module 850 may be disposed between the first switch 820 and the second antenna 870 on the second path. The PA module 850 may include a phase shifter and a power amplifier (PA) configured to support ENDC and EPA simultaneously. The phase shifter may be included in the PA module 850 as illustrated in FIG. 8, but the present disclosure is not limited thereto and the phase shifter may be implemented in various forms. The phase shifter is described with reference to FIG. 10.

The first antenna 860 may transmit a first signal output from the TRx module 840 through first network communication, and may be disposed in a first part of the electronic device 800. For example, the first network communication may be and/or may include LTE communication. However, the present disclosure is not limited in this regard.

The second antenna 870 may transmit a second signal output from the PA module 850 through second network communication, and may be disposed in a second part of the electronic device 800. For example, the second network communication may be and/or may include 5G communication. However, the present disclosure is not limited in this regard.

The second switch 830 may connect the TRx module 840 and/or the PA module 850 to a feedback receiving end FBRx of the RFIC 810. For example, the second switch 830 may be an SP4T switch or a single pole double throw (SPDT) switch that may connect one of a plurality of inputs to an output terminal.

A communication processor (CP) (e.g., the auxiliary processor 123 of FIG. 1) may control the RFIC 810 and/or RFFE according to an EPA state, perform phase matching between a first signal and a second signal, and store a result of performing the phase matching in a memory.

An application processor (AP) (e.g., the main processor 121 of FIG. 1) may be a processor (e.g., a central processing unit (CPU)) configured to run an operating system (OS) and application of the electronic device 800. The AP may detect a state (e.g., a folded state or unfolded state) of the electronic device 800, and transmit a result of detecting the state to the CP.

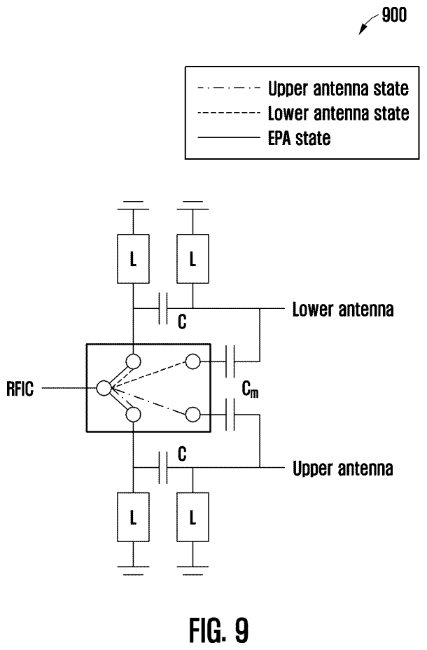

FIG. 9 is a diagram illustrating a switch, according to an embodiment.

Referring to FIG. 9, a first switch 900 (e.g., the first switch 820 of FIG. 8) may transmit a transmission signal input from an RFIC (e.g., the RFIC 810 of FIG. 8) to a lower antenna (e.g., the LB lower antenna 510 of FIG. 5 and the first antenna 860 of FIG. 8) and/or an upper antenna (e.g., the LB upper antenna 520 of FIG. 5 and the second antenna 870 of FIG. 8). In an EPA state, the first switch 900 may transmit a transmission signal input from the RFIC to both the upper antenna and the lower antenna.

In a case where a phase shifter is not included in the PA module 850 of FIG. 8 and the first switch 900 supports a single band EPA, the first switch 900 may be divided into a path of a lower inductor and a capacitor and a path of an upper inductor and a capacitor, when the first switch 900 operates in the EPA state. The inductors and capacitors included in the first switch 900 may act as a phase shifter. The inductors and capacitors may have values for fixing a phase according to the single band EPA.

According to an embodiment, an electronic device may include an RFIC. The electronic device may include a first switch connecting a transmitting end of the RFIC to a first path to a first antenna and/or a second path to a second antenna. The electronic device may include a TRx module disposed between the first switch and the first antenna on the first path. The electronic device may include the first antenna configured to transmit the first signal output from the TRx module through first network communication, and disposed in a first part in the electronic device. The electronic device may include a PA module disposed between the first switch and the second antenna on the second path. The electronic device may include the second antenna configured to transmit the second signal output from the PA module through second network communication, and disposed in a second part in the electronic device. The electronic device may include a second switch connecting the TRx module and/or the PA module to a feedback receiving end of the RFIC. When the electronic device is closed, the first antenna and the second antenna may be disposed in close proximity to each other. A phase between the first signal and the second signal may be matched based on a feedback signal transmitted from the TRx module and/or the PA module to the feedback receiving end of the RFIC through the second switch.

According to an embodiment, when the electronic device is in an EPA state, the first switch may connect the transmitting end of the RFIC to the first path and the second path. The first switch may divide a signal output from the transmitting end of the RFIC to transmit to the first path and the second path.

According to an embodiment, the electronic device may include a phase shifter disposed on the second path. The second switch may add the feedback signals transmitted from the TRx module and the PA module to transmit to the feedback receiving end of the RFIC. The phase shifter may adjust a phase of a signal transmitted to the second path on which the phase shifter is disposed according to a sum of power magnitudes of the first signal and the second signal.

According to an embodiment, the electronic device may include a memory storing a phase adjusted by the phase shifter.

According to an embodiment, the memory may store a hardware gain of the feedback receiving end of the RFIC in a state in which the phase is adjusted by the phase shifter.

According to an embodiment, the phase adjusted by the phase shifter and the hardware gain of the feedback receiving end of the RFIC may be determined with respect to each of a high gain range and a low gain range of a PA and may be stored in the memory.

According to an embodiment, the second switch may transmit a feedback signal transmitted from the PA module to the feedback receiving end of the RFIC. A delayed phase of the feedback signal may be stored in the memory.

According to an embodiment, the first switch may include one or more inductors and one or more capacitors having a phase corresponding to an EPA-supported frequency.

According to an embodiment, when the electronic device is closed, the electronic device may operate in the EPA state.

FIG. 10 is a diagram describing an operating method of an electronic device, according to an embodiment.

In the following embodiments, each of the operations may be sequentially performed, but are not necessarily performed sequentially. For example, the order of the operations may be changed, and at least two operations may be performed in parallel. Operations 1001 to 1014 may be performed by at least one component of an electronic device (e.g., the electronic device 101 of FIG. 1, the electronic device 210 of FIG. 2, the electronic device 300 of FIG. 3, the electronic device 400 of FIG. 4, the electronic device 500 of FIG. 5, the electronic device 600 of FIG. 6, the electronic device 700 of FIG. 7, or the electronic device 800 of FIG. 8).

In operation 1001, the electronic device may identify a network ENDC configuration. For example, the electronic device may identify a network environment with a base station by identifying the rrcConnection-Reconfiguration. In operation 1002, the electronic device may determine whether a PA module (e.g., the PA module 850 of FIG. 8) for ENDC is available for use according to a network state. The electronic device may determine whether the ENDC of an EPA PA is activated.

When a configuration of a corresponding combination of ENDC LB-LB is identified with the network environment of the ENDC as a priority (Yes in operation 1002), in operation 1003, an EPA state may be deactivated (a non-EPA mode) regardless of whether the electronic device is folded. In operation 1003, a first switch (e.g., the first switch 820 of FIG. 8 or the first switch 900 of FIG. 9) may connect an RFIC (e.g., the RFIC 810 of FIG. 8) to a first path to a first antenna (e.g., the LB lower antenna 510 of FIG. 5 and the first antenna 860 of FIG. 8), and the electronic device may perform communication using the first antenna. Such a communication path may effectively reduce insertion loss (IL), when compared to a related electronic device.

When the ENDC of the EPA PA is deactivated (No in operation 1002), in operation 1004, it may be determined whether the electronic device is currently in a folded state. For example, when the PA module is not used, such as in the cases of LTE CA or NR standalone (SA), the electronic device may operate in the EPA state according to whether the electronic device is folded. When the electronic device is in the folded state (Yes in operation 1004), operation 1005 may be subsequently performed, and when the electronic device is in an unfolded state (No in operation 1004), operation 1003 may be subsequently performed.

In operation 1005, the electronic device may operate the first switch in the EPA state. In the EPA state, the first switch may connect a transmitting end (e.g., TX0_LB1) of the RFIC to both the first path to the first antenna and a second path to a second antenna (e.g., the LB upper antenna 520 of FIG. 5 and the second antenna 870 of FIG. 8). For example, the first switch may divide a transmission signal of the RFIC by −3 dB each to transmit to the first path and the second path. Since the first path and the second path are different RF paths, a phase difference may occur at each antenna end, which may result in a power mismatch of the transmission signal and significant power loss of the transmission signal. A process of compensating for a phase difference to prevent the occurrence of a power mismatch is described below.

In operation 1006, the electronic device may perform calibration on a TRx module and the PA module in the EPA state, and store an EPA non-volatile (NV) value. The power of the transmission signal of the RFIC transmitted to the first path and the second path while passing through the first switch may be divided by −3 dB. Calibration may be performed on the first path and the second path for each network communication (e.g., LTE and NR), and a result of the calibration may be stored in a memory.

In operation 1007, the electronic device may determine whether an EPA sum of an output of an upper end and a lower end is +3 dB. As described above, since the EPA sum is not +3 dB when there is a phase difference in the transmission path (No in operation 1007), operation 1008 may be subsequently performed. When the EPA sum is +3 dB since there is no phase difference in the transmission path (Yes in operation 1007), operation 1011 may be subsequently performed. The upper end may represent the second path, and the lower end may represent the first path.

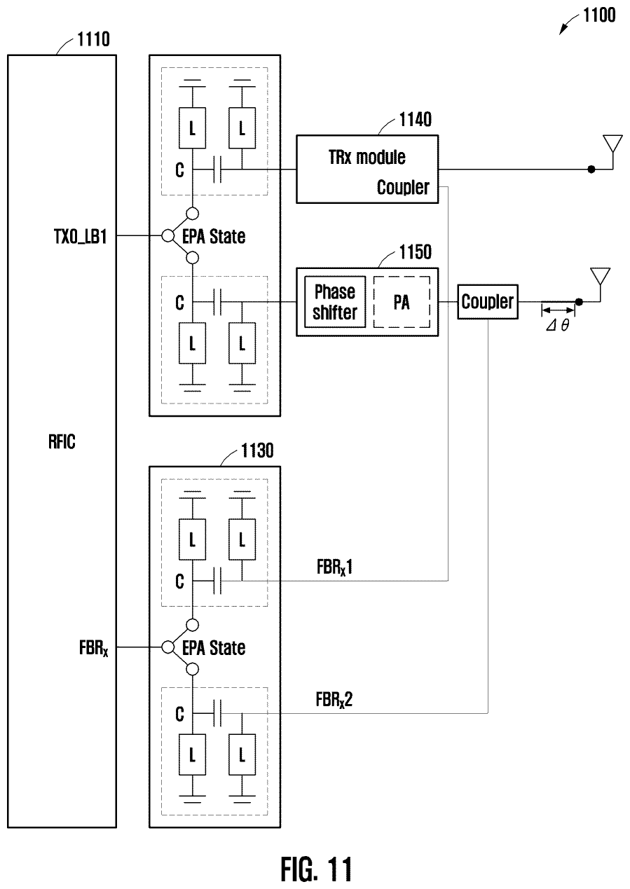

In operation 1008, the electronic device may adjust a phase at a phase shifter of the upper end. Here, a phase of the lower end may be fixed without being adjusted separately. For example, the electronic device may increase or decrease a phase by a predetermined size. Operation 1008 is described with reference to FIGS. 11 to 14.

In operation 1009, in a state in which a phase is adjusted, the electronic device may determine whether the EPA sum of the output of the upper end and the lower end is +3 dB. When the EPA sum is not +3 dB (No in operation 1009), a phase adjusting operation may be performed again in operation 1008. When the EPA sum is +3 dB (Yes in operation 1009), it may be determined that the phase matching is completed and operation 1010 may be subsequently performed. Operation 1009 is further described with reference to FIGS. 11 to 14.

In operation 1010, the electronic device may store the adjusted phase in a memory. Since the phases of an upper signal and a lower signal are matched through the phase adjustment, the adjusted phase may also be referred to as a phase delay α. The upper signal may represent a second signal transmitted through the second antenna connected to the second path, and the lower signal may represent a first signal transmitted through the first antenna connected to the first path.

In operation 1011, the electronic device may operate the second switch in an EPA addition mode. For example, the second switch may be an SP4T switch. In operation 1012, the electronic device may store an EPA FBRx hardware gain value in the memory. Operations 1011 and 1012 are further described with reference to FIGS. 11 to 14.

In operation 1013, the electronic device may operate an upper antenna and a lower antenna in the EPA mode, and the electronic device may operate with a calibration value of the phase delay and the FBRx hardware gain.

In operation 1014, the electronic device may correct the phase delay and the EPA FBRx hardware gain in real time to maintain the calibrated value.

FIGS. 11 to 14 are diagrams illustrating an operation of matching a phase between a first signal and a second signal, according to an embodiment.

Referring to FIG. 11, an example of an electronic device 1100 (e.g., (e.g., the electronic device 101 of FIG. 1, the electronic device 210 of FIG. 2, the electronic device 300 of FIG. 3, the electronic device 400 of FIG. 4, the electronic device 500 of FIG. 5, the electronic device 600 of FIG. 6, the electronic device 700 of FIG. 7, or the electronic device 800 of FIG. 8) for matching a phase between a lower signal and an upper signal and for obtaining an EPA FBRx hardware gain is illustrated.

A phase of the upper signal may be adjusted by a phase shifter included in a PA module 1150 (e.g., the PA module 850 of FIG. 8) to match the phases between the upper signal and the lower signal. An example of an EPA value according to the phase adjustment by the phase shifter may be expressed as shown in Table 1 below.

TABLE 1
EPA

| Phase | Phase NV | EPA FBRx HW Gain | EPA Power |
|---|---|---|---|
| 0 | 40 | 173 | 12.6 |
| 20 | 43 | 215 | 16.8 |
| 40 | 47 | 263 | 18.7 |
| 60 | 48 | 402 | 23.2 |
| 80 | 50 | 290 | 20.4 |
| 90 | 51 | 283 | 19.4 |
| 120 | 52 | 245 | 18.5 |

In Table 1, Phase may represent a phase of the lower signal, Phase NV may represent a converted value of the Phase value in order to store the Phase value in a memory, EPA FBRx HW Gain may represent an EPA FBRx hardware gain value for each Phase value, and EPA Power may represent a power sum of the lower signal and the upper signal.

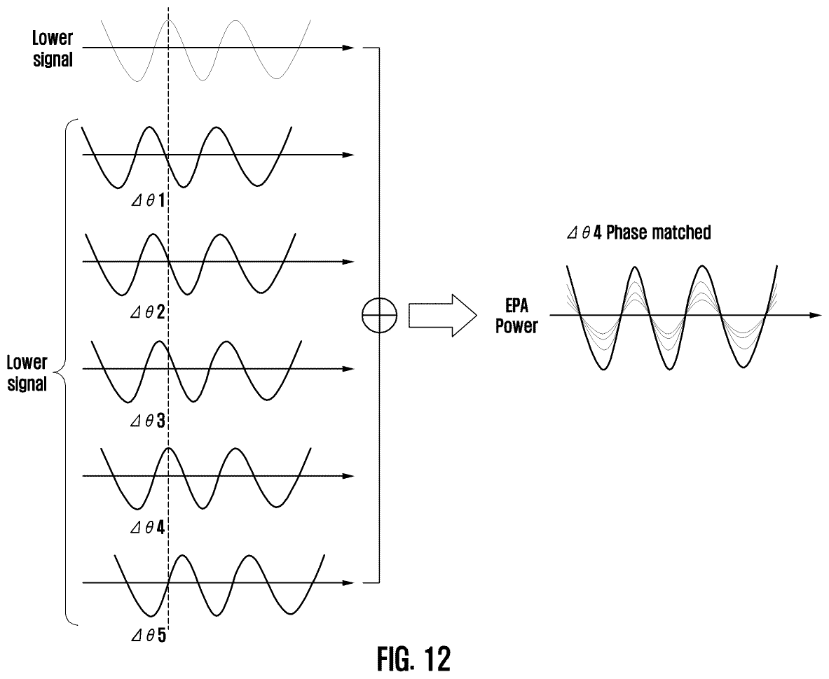

Referring to a phase matching operation between a lower signal and an upper signal with reference to FIG. 12, a phase of the lower signal may be fixed without being adjusted as shown in FIG. 12. The phase shifter may control a phase of the upper signal, and may, for example, control the phase of the upper signal by using a phase value described in Table 1. The phase of the upper signal may be determined according to a sum of the power magnitudes of the lower signal and the upper signal. For example, when the power magnitudes of each of the lower signal and the upper signal are 20 dB, a sum of the power magnitudes of the lower signal and the upper signal in a phase-matched state may be 23 dB. Using such characteristics, the phase of the upper signal may be controlled to be 60 degrees where the EPA power comes close to 23 dB. In an example of FIG. 12, the upper signal may be controlled such that the phase of the upper signal is 404, which may be most matched (e.g., similar) to the phase of the lower signal.

Returning to FIG. 11, in a state in which the phases of the lower signal and the upper signal are matched, the EPA FBRx hardware gain may be determined through a second switch 1130 (e.g., the second switch 830 of FIG. 8). The second switch 1130 may add a first feedback signal FBRx1 from a TRx module 1140 (e.g., the TRx module 840 of FIG. 8) and a second feedback signal FBRx2 from the PA module 1150 (e.g., the PA module 850 of FIG. 8) and transmit the added signals to an RFIC 1110 (e.g., the RFIC 810 of FIG. 8). The second switch 1130 may operate similarly to the EPA state described with reference to FIG. 9.

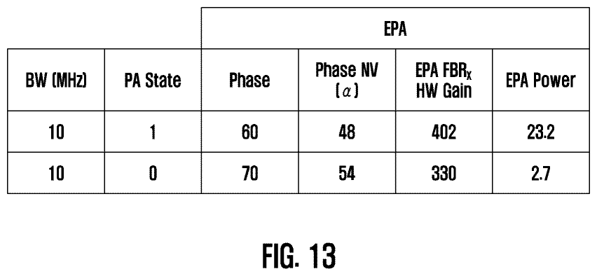

Referring to FIG. 13, a phase value that matches the phase between the lower signal and the upper signal and the EPA FBRx hardware gain may be determined for each PA state. The PA state may include a high gain state (e.g., when the PA state is one (1) and/or a high level) in which a plurality of inner amplifiers is used and a low gain state (e.g., when the PA state is zero (0) and/or a low level) in which only some inner amplifiers may be used. The matched phase value and the EPA FBRx hardware gain described above may be determined in the high gain state and the low gain state respectively, and stored in a memory. The phases between the lower signal and the upper signal may be effectively matched in various PA ranges.

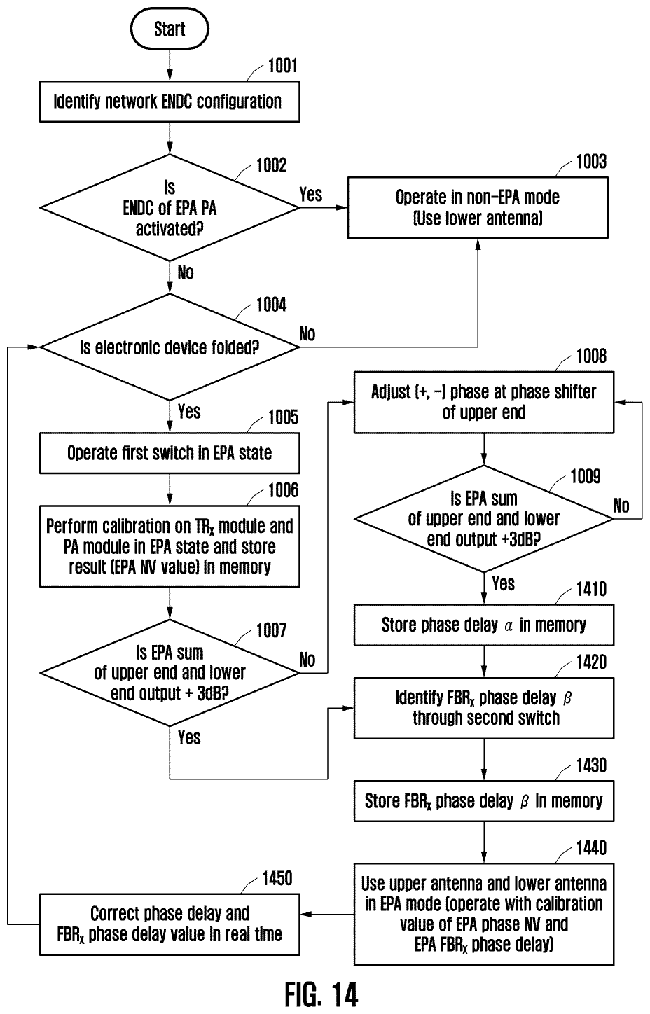

FIG. 14 is a diagram describing an operating method of an electronic device, according to an embodiment.

In the following embodiments, each of the operations may be sequentially performed, but are not necessarily performed sequentially. For example, the order of the operations may be changed, and at least two operations may be performed in parallel. The operations illustrated in FIG. 14 may be performed by at least one component of an electronic device (e.g., the electronic device 101 of FIG. 1, the electronic device 210 of FIG. 2, the electronic device 300 of FIG. 3, the electronic device 400 of FIG. 4, the electronic device 500 of FIG. 5, the electronic device 600 of FIG. 6, the electronic device 700 of FIG. 7, the electronic device 800 of FIG. 8, or the electronic device 1100 of FIG. 11).

FIG. 14 illustrates an operation of the electronic device when a second switch (e.g., the second switch 830 of FIG. 8 and the second switch 1130 of FIG. 11) is an SPDT switch configured to connect one of a plurality of inputs to an output terminal. Except for operations 1410 to 1450 in FIG. 14, the remaining operations may be applied as described with reference to FIG. 10, so a detailed description thereof may be omitted for the sake of brevity.

In operation 1410, the electronic device may store an adjusted phase in a memory. As described above, since the phases of the upper signal and the lower signal are matched through phase adjustment, the adjusted phase may also be referred to as a phase delay α.

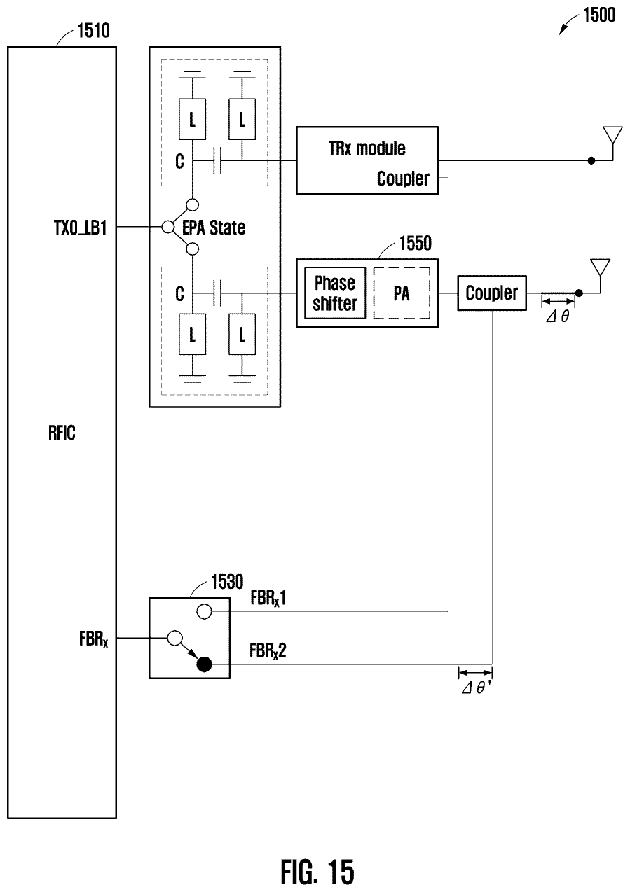

In operation 1420, the electronic device may identify an FBRx phase delay β through the second switch. The phase delay α that occurs in a second path may appear as the FBRx phase delay β in a feedback path connected from the second path to the second switch. In operation 1430, the electronic device may store the FBRx phase delay β in a memory. Operations 1420 and 1430 are further described with reference to FIGS. 15 to 17.

In operation 1440, the electronic device may operate an upper antenna and a lower antenna in an EPA mode, and the electronic device may operate with a calibration value of the phase delay and the FBRx phase delay.

In operation 1450, the electronic device may correct the phase delay and the FBRx phase delay in real time to maintain the calibrated value.

FIGS. 15 to 17 are diagrams illustrating an operation of matching a phase between a first signal and a second signal, according to an embodiment.

Referring to FIG. 15, an example of an electronic device 1500 (e.g., the electronic device 101 of FIG. 1, the electronic device 210 of FIG. 2, the electronic device 300 of FIG. 3, the electronic device 400 of FIG. 4, the electronic device 500 of FIG. 5, the electronic device 600 of FIG. 6, the electronic device 700 of FIG. 7, the electronic device 800 of FIG. 8, or the electronic device 1100 of FIG. 11) for obtaining an FBRx phase delay through a second switch (e.g., the second switch 830 of FIG. 8 and the second switch 1130 of FIG. 11) is illustrated.

A phase matching operation between a lower signal and an upper signal may be applied as described with reference to FIGS. 11 to 13, so a detailed description thereof may be omitted for the sake of brevity.

In a state in which the phases between the lower signal and the upper signal are matched, an FBRx phase delay 40′ may be identified through a second feedback signal FBRx2 transmitted from a PA module 1550 (e.g., the PA module 850 of FIG. 8 and the PA module 1150 of FIG. 11) to a second switch 1530.

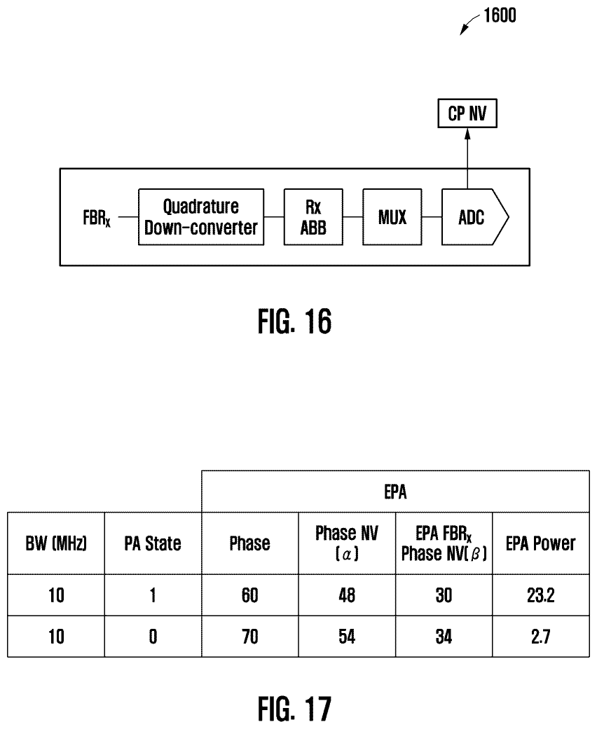

Referring to the second feedback signal FBRx2 received at an FBRx end of an RFIC 1510 (e.g., the RFIC 810 of FIG. 8 and the RFIC 1110 of FIG. 11) through the second switch with reference to FIG. 16, the second feedback signal may be transmitted to a CP through a quadrature down-converter, a receiver analog baseband (RX ABB), a multiplexer (MUX), and an analog digital converter (ADC) such that the FBRx phase delay 40′ is identified and stored in a memory.

FIG. 17 illustrates an example of a phase delay α and an FBRx phase delay β in which phase matching occurs between a lower signal and an upper signal for each PA state. In FIG. 17, Phase may represent a phase of the lower signal, Phase NV may represent a converted value of the Phase value in order to store the Phase value in a memory, and EPA FBRx Phase NV (β) may represent a converted value of the FBRx phase delay β in order to store the FBRx phase delay β in a memory.

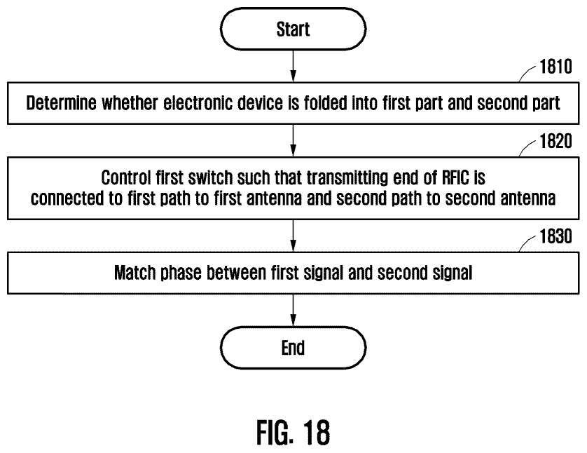

FIG. 18 is a diagram illustrating an operating method of an electronic device, according to an embodiment.

In the following embodiments, each of the operations may be sequentially performed, but are not necessarily performed sequentially. For example, the order of the operations may be changed, and at least two operations may be performed in parallel. The operations illustrated in FIG. 18 may be performed by at least one component of an electronic device (e.g., the electronic device 101 of FIG. 1, the electronic device 210 of FIG. 2, the electronic device 300 of FIG. 3, the electronic device 400 of FIG. 4, the electronic device 500 of FIG. 5, the electronic device 600 of FIG. 6, the electronic device 700 of FIG. 7, the electronic device 800 of FIG. 8, the electronic device 1100 of FIG. 11, or the electronic device 1500 of FIG. 15).

In operation 1810, the electronic device may determine whether the electronic device is folded into a first part and a second part. In operation 1820, in response to the electronic device being folded, the electronic device may control a first switch (e.g., the first switch 820 of FIG. 8 or the first switch 900 of FIG. 9) such that a transmitting end of an RFIC (e.g., the RFIC 810 of FIG. 8, the RFIC 1110 of FIG. 11, or the RFIC 1510 of FIG. 15) is connected to a first path to a first antenna (e.g., the LB lower antenna 510 of FIG. 5 or the first antenna 860 of FIG. 8) and a second path to a second antenna (e.g., the LB upper antenna 520 of FIG. 5 or the second antenna 870 of FIG. 8). In operation 1830, the electronic device may match a phase between a first signal output from a TRx module and a second signal output from a PA module, based on a feedback signal transmitted from the TRx module (e.g., the TRx module 840 of FIG. 8 or the TRx module 1140 of FIG. 11) on the first path and/or a feedback signal transmitted from the PA module (e.g., the PA module 850 of FIG. 8, the PA module 1150 of FIG. 11, or the PA module 1550 of FIG. 15) on the second path to a feedback receiving end of the RFIC through a second switch (e.g., the second switch 830 of FIG. 8, the second switch 1130 of FIG. 11, or the second switch 1530 of FIG. 15). The TRx module may be disposed between the first switch and the first antenna on the first path, and the PA module may be disposed between the first switch and the second antenna on the second path. When the electronic device is folded, the first antenna and the second antenna may be disposed in close proximity to each other. The first antenna may transmit the first signal through first network communication, and the second antenna may transmit the second signal through second network communication.

In an embodiment, for the controlling of the first switch, a signal output from the transmitting end of the RFIC may be divided and transmitted to the first path and the second path.

In an embodiment, for the matching of the phase, a phase of a signal transmitted to the second path on which a phase shifter is disposed may be adjusted according to a sum of the power magnitudes of the feedback signals from the TRx module and the PA module by the second switch.

In an embodiment, the operating method of the electronic device may further include an operation of storing a phase adjusted by the phase shifter in a memory.

In an embodiment, for the storing in the memory, a hardware gain of the feedback receiving end of the RFIC in a state in which the phase is adjusted by the phase shifter may be further stored.

In an embodiment, for the storing in the memory, the phase adjusted by the phase shifter and the hardware gain of the feedback receiving end of the RFIC, which are determined with respect to each of a high gain range and a low gain range of a PA, may be stored in the memory.

In an embodiment, the operating method of the electronic device may further include storing a delayed phase of the feedback signal transmitted from the PA module to the feedback receiving end of the RFIC through the second switch in the memory.

In an embodiment, the first switch may include one or more inductors and one or more capacitors having a phase corresponding to an EPA-supported frequency.

The electronic device may utilize an ENDC circuit and match a phase between a lower and an upper signal while supporting EPA without the need for additional components that may increase IL, when compared to a related electronic device. The electronic device may divide and transmit a transmission signal output from the transmitting end of the RFIC to an upper path and a lower path through the first switch to minimize degradation of communication performance even when the electronic device is folded.

The embodiments disclosed in the present specification and the drawings are intended merely to present specific examples in order to aid in understanding of the present disclosure, but are not intended to limit the scope of the present disclosure. It is to be apparent to those skilled in the art that various modifications based on the technical spirit of the present disclosure, as well as the disclosed embodiments, may be made.

What is claimed is:

1. An electronic device comprising:
a radio-frequency integrated circuit (RFIC);
a first switch configured to couple a transmitting end of the RFIC to at least one of a first path to a first antenna or a second path to a second antenna;
a TRx module disposed between the first switch and the first antenna on the first path;
the first antenna configured to transmit a first signal output from the TRx module through first network communication, and disposed in a first part of the electronic device;
a power amplifier (PA) module disposed between the first switch and the second antenna on the second path;
the second antenna configured to transmit a second signal output from the PA module through second network communication, and disposed in a second part of the electronic device; and
a second switch configured to couple at least one of the TRx module or the PA module to a feedback receiving end of the RFIC,
wherein, in a folded state of the electronic device in which the first part and the second part are folded relative to each other, the first antenna and the second antenna are disposed in close proximity to each other, and
wherein a phase is matched between the first signal and the second signal based on a feedback signal transmitted from at least one of the TRx module or the PA module to the feedback receiving end of the RFIC through the second switch.

2. The electronic device of claim 1, wherein the first switch is further configured to:
couple the transmitting end of the RFIC to the first path and the second path based on the electronic device being in an equivalent phase antenna (EPA) state;
divide a signal output from the transmitting end of the RFIC into a first portion and a second portion; and
transmit the first portion to the first path and transmit the second portion to the second path.

3. The electronic device of claim 1, further comprising:
a phase shifter disposed on the second path,
wherein the second switch is further configured to:
generate output feedback signals by adding first feedback signals from the TRx module and second feedback signals from the PA module; and
transmit the output feedback signals to the feedback receiving end of the RFIC, and
wherein the phase shifter is configured to adjust a phase of a signal transmitted to the second path on which the phase shifter is disposed, based on a sum of power magnitudes of the first signal and the second signal.

4. The electronic device of claim 3, further comprising:
a memory configured to store the phase adjusted by the phase shifter.

5. The electronic device of claim 4, wherein the memory is further configured to:
store a hardware gain of the feedback receiving end of the RFIC in a state in which the phase is adjusted by the phase shifter.

6. The electronic device of claim 5, wherein the phase adjusted by the phase shifter and the hardware gain of the feedback receiving end of the RFIC are determined with respect to each of a high gain range and a low gain range of a power amplifier (PA).

7. The electronic device of claim 1, wherein the second switch is further configured to transmit a feedback signal transmitted from the PA module to the feedback receiving end of the RFIC, and
wherein a delayed phase of the feedback signal is stored in a memory.

8. The electronic device of claim 1, wherein the first switch comprises at least one inductor and at least one capacitor, and
wherein the first switch has a phase shift corresponding to an equivalent phase antenna (EPA)-supported frequency.

9. The electronic device of claim 1, wherein, in the folded state in which the electronic device, the electronic device the configured to operate in an equivalent phase antenna (EPA) state.

10. An operating method of an electronic device that is foldable, the operating method comprising:
identifying whether the electronic device is in a folded state in which a first part of the electronic device and a second part of the electronic device are folded relative;
based on identifying that the electronic device is in the folded state, controlling a first switch such that a transmitting end of an radio-frequency integrated circuit (RFIC) is coupled to a first path to a first antenna and a second path to a second antenna;
matching a phase between a first signal output from a TRx module and a second signal output from a power amplifier (PA) module, based on a feedback signal transmitted, through a second switch, from at least one of the TRx module on the first path or the PA module on the second path to a feedback receiving end of the RFIC,
wherein the TRx module is disposed between the first switch (820, 900) and the first antenna on the first path, and the PA module is disposed between the first switch and the second antenna on the second path,
wherein, in the folded state of the electronic device, the first antenna and the second antenna are disposed in close proximity to each other,
wherein the first antenna is configured to transmit the first signal through a first network communication, and
wherein the second antenna is configured to transmit the second signal through a second network communication.

11. The operating method of claim 10, wherein the controlling of the first switch comprises:
dividing a signal output from the transmitting end of the RFIC into a first portion and a second portion;
transmitting the first portion to the first path; and
transmitting the second portion to the second path.

12. The operating method of claim 10, wherein the matching of the phase comprises:
adjusting a phase of a signal transmitted to the second path on which a phase shifter is disposed, based on a sum of power magnitudes of feedback signals transmitted, by the second switch, from the TRx module and the PA module.

13. The operating method of claim 10, further comprising:
storing a phase adjusted by a phase shifter in a memory.

14. The operating method of claim 13, wherein the storing of the phase comprises:
storing a hardware gain of the feedback receiving end of the RFIC in a state in which the phase is adjusted by the phase shifter.

15. The operating method of claim 14, wherein the storing of the phase further comprises:
determining the phase adjusted by the phase shifter and the hardware gain of the feedback receiving end of the RFIC, with respect to each of a high gain range and a low gain range of a power amplifier (PA).
